(19) United States
(12) Patent Application Publication
(10) Pub. No.: US 2023/0107273 A1
(43) Pub. Date: Apr. 6, 2023

(54) ALUMINUM ANODE CURRENT COLLECTORS FOR LITHIUM ION BATTERIES

(71) Applicants: Novelis Inc., Atlanta, GA (US); Georgia Tech Research Corporation, Atlanta, GA (US)

(72) Inventors: Diptarka Majumdar, Cumming, GA (US); Venkatesh Sundaram, Johns Creek, GA (US); Matthew McDowell, Decatur, GA (US); Francisco J. Quintero Cortes, Atlanta, GA (US); DaeHoon Kang, Canton, GA (US)

(73) Assignees: Novelis Inc., Atlanta, GA (US); Georgia Tech Research Corporation, Atlanta, GA (US)

(21) Appl. No.: 17/905,658

(22) PCT Filed: Mar. 8, 2021
(86) PCT No.: PCT/US2021/070250

§ 371 Date: Sep. 6, 2022

Related U.S. Application Data
(60) Provisional application No. 62/987,103, filed on Mar. 9, 2020.
(60) Provisional application No. 63/107,289, filed on Oct. 29, 2020.

(51) Int. Cl. H01M 4/62; H01M 4/66; H01M 10/0525

(52) U.S. Cl. CPC H01M 4/628; H01M 4/662; H01M 10/0525

(57) ABSTRACT

Described are substrates including a layer of an aluminum alloy with a conductive coating, also referred to as a protective overlayer. The conductive coating can prevent certain material from coming into contact with the aluminum alloy layer while allowing transmission of electrons to the aluminum alloy. The substrates may be used, for example, in electronics applications, such as current collectors or electrodes for batteries, electrochemical cells, capacitors, supercapacitors, or the like.

### CROSS-REFERENCE TO RELATED APPLICATIONS

This application claims the benefit of and priority to U.S. Provisional Application No. 62/987,103, filed on Mar. 9, 2020, and U.S. Provisional Application No. 63/107,289, filed on Oct. 29, 2020, which are hereby incorporated by reference in their entireties.

### FIELD

The present disclosure relates to current collectors for electrochemical cells and more specifically to aluminum current collectors used in electrodes of an electrochemical cell.

### BACKGROUND

In conventional lithium ion batteries, copper is used as the anode current collector and aluminum is used as the cathode current collector. Aluminum generally cannot be used as the current collector on the anode side in a lithium ion battery because of reactive alloying of aluminum by lithium at the anode potentials. Advances are needed if aluminum is to be used as an anode current collector in a lithium ion battery.

### SUMMARY

The term embodiment and like terms are intended to refer broadly to all of the subject matter of this disclosure and the claims below. Statements containing these terms should be understood not to limit the subject matter described herein or to limit the meaning or scope of the claims below. Embodiments of the present disclosure covered herein are defined by the claims below, not this summary. This summary is a high-level overview of various aspects of the disclosure and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this disclosure, any or all drawings and each claim.

Described herein are aluminum alloy-based substrates, useful for applications such as electronic substrates, battery electrodes, battery current collectors, capacitor electrodes, capacitor current collectors, or the like. In some examples, a substrate comprises an aluminum alloy layer; and a conductive protection layer in contact with the aluminum alloy layer.

The conductive protection layer may allow transmission of electrons from external to the conductive protection layer to the aluminum alloy layer, and may otherwise serve to protect the underlying aluminum alloy layer from being subjected to corrosive conditions, destructive conditions, being rendered non-conductive, or from being contacted with materials that may corrode, destroy, render the aluminum alloy layer non-conductive. In some examples, the conductive protection layer may have an electrical conductivity of from 10⁵ S/m to 10⁸ S/m or an electrical resistivity of from 10⁻⁸ Ω·m to 10⁻⁶ Ω·m. The conductive protection layer may prevent transmission of lithium atoms or lithium ions to the aluminum alloy layer, for example. The conductive layer may be free or substantially free of imperfections allowing transmission of lithium atoms or lithium ions to the aluminum alloy layer. For example, the conductive protection layer may be free or substantially free of imperfections extending between a surface of the conductive protection layer facing the aluminum alloy layer and an opposite surface of the conductive protection layer. The conductive protection layer may comprise a coating on the aluminum alloy layer or the aluminum alloy layer may comprise a coating on the conductive protection layer. Depending on the configuration, the conductive protection layer may coat all or only a portion of the aluminum alloy layer. In some cases, for example, the conductive protection layer may comprise a complete encapsulation layer over all or the portion of the aluminum alloy layer. In other cases, the conductive protection layer may cover a portion of the aluminum alloy layer and the aluminum alloy layer may extend from or beyond the conductive protection layer, such as to make contact with an external circuit.

Although the conductive protection layer may be electrically conductive, not all electrically conductive materials are useful as the conductive protection layer. For example, a conductive protection layer of aluminum may not provide adequate protection for the underlying aluminum alloy layer. In some examples, the conductive protection layer comprises a material that does not alloy with lithium. Stated another way, the conductive protection layer does not include materials that alloy with lithium, in some embodiments. For example, in various embodiments, the conductive protection layer does not include aluminum, zinc, magnesium, silicon, germanium, tin, indium, antimony, or carbon.

Optionally, the conductive protection layer comprises a material that does not react with lithium at a potential of from 0 V to 5 V vs. Li/Li⁺, such as at a potential of from 0 V to 1 V, from 1 V to 2 V, from 2 V to 3 V, from 3 V to 3.2 V, from 3.2 V to 4 V, or from 4 V to 5 V (all vs. Li/Li⁺). In some examples, the conductive protection layer comprises one or more of titanium, chromium, iron, nickel, molybdenum, tungsten, copper, or titanium nitride.

Although not so limited, the conductive protection layer may have a purity of 70 wt. % or more, such as 71 wt. % or more, 72 wt. % or more, 73 wt. % or more, 74 wt. % or more, 74 wt. % or more, 75 wt. % or more, 76 wt. % or more, 77 wt. % or more, 78 wt. % or more, 79 wt. % or more, 80 wt. % or more, 81 wt. % or more, 82 wt. % or more, 83 wt. % or more, 84 wt. % or more, 85 wt. % or more, 86 wt. % or more, 87 wt. % or more, 88 wt. % or more, 89 wt. % or more, 90 wt. % or more, 91 wt. % or more, 92 wt. % or more, 93 wt. % or more, 94 wt. % or more, 95 wt. % or more, 96 wt. % or more, 97 wt. % or more, 98 wt. % or more, 99 wt. % or more, 99.9 wt. % or more, or 99.99 wt. % or more. The conductive protection layer may comprise a metal layer having an impurity content of 30 wt. % or less, 25 wt. % or less, 20 wt. % or less, 15 wt. % or less, 10 wt. % or less, 9 wt. % or less, 8 wt. % or less, 7 wt. % or less, 6 wt. % or less, 5 wt. % or less, 4 wt. % or less, 3 wt. % or less, 2 wt. % or less, 1 wt. % or less, 0.1 wt. % or less, or 0.01 wt. % or less. In some configurations, it may be desirable to limit the amount of oxygen in the conductive protection layer. Example conductive protection layers may include an oxygen content of 30 wt. % or less, 25 wt. % or less, 20 wt. % or less, 15 wt. % or less, 10 wt. % or less, 9 wt. % or less, 8 wt. % or less, 7 wt. % or less, 6 wt. % or less, 5 wt. % or less, 4 wt. % or less, 3 wt. % or less, 2 wt. % or less, 1 wt. % or less, 0.1 wt. % or less, or 0.01 wt. % or less.

The conductive protection layer may optionally comprise a composite structure, such as where the conductive protection layer is made up from two or more different materials positioned in contact with one another. In some examples, the conductive protection layer may comprise multiple sub-layers where each sub-layer may be different from the other layers. Each of the sub-layers of such a conductive protection layer may independently have a different purity from other sub-layers. Optionally, the composite structure comprises at least a first sub-layer and a second sub-layer, and wherein the first sub-layer and the second sub-layer comprise the same material or different materials. Optionally, each sub-layer independently has a purity of 70 wt. % or more, 75 wt. % or more, or 80 wt. % or more.

Optionally, the aluminum alloy layer may be generated on a conductive protection layer using any suitable technique. Examples of the aluminum alloy layer include, but are not limited to a physically deposited layer, a sputter deposited layer, an evaporation deposition deposited layer, a chemically deposited layer, an electrodeposition deposited layer, an electroplated layer, a chemical vapor deposited layer, or an atomic layer deposited layer. Optionally, the aluminum alloy layer comprises a crystalline structure or a polycrystalline structure. Optionally, the aluminum alloy layer comprises a deposited coating over a conductive protection layer comprising a metal or metal alloy foil.

Optionally, the conductive protection layer may be generated on an aluminum alloy layer using any suitable technique. Examples of the conductive protection layer include, but are not limited to a physically deposited layer, a sputter deposited layer, an evaporation deposition deposited layer, a chemically deposited layer, an electrodeposition deposited layer, an electroplated layer, a chemical vapor deposited layer, or an atomic layer deposited layer. Optionally, the conductive protection layer comprises a crystalline structure or a polycrystalline structure. Optionally, the conductive protection layer comprises a deposited coating over an aluminum alloy layer comprising an aluminum alloy foil.

The conductive protection layer or one or more sub-layers thereof may have any suitable thickness to provide suitable conductivity and protection. For example, the conductive protection layer or one or more sub-layers thereof may have a thickness of from about 10 nm to about 100 μm, such as from 10 nm to 50 nm, from 10 nm to 100 nm, from 10 nm to 1 μm, from 10 nm to 5 μm, from 10 nm to 10 μm, from 10 nm to 50 μm, from 10 nm to 100 μm, from 50 nm to 100 nm, from 50 nm to 500 nm, from 50 nm to 1 μm, from 50 nm to 5 μm, from 50 nm to 10 μm, from 50 nm to 50 μm, from 50 nm to 100 μm, from 100 nm to 500 nm, from 100 nm to 1 μm, from 100 nm to 5 μm, from 100 nm to 10 μm, from 100 nm to 50 μm, from 100 nm to 100 μm, from 500 nm to 1 μm, from 500 nm to 5 μm, from 500 nm to 10 μm, from 500 nm to 50 μm, from 500 nm to 100 μm, from 1 μm to 5 μm, from 1 μm to 10 μm, from 1 μm to 50 μm, from 1 μm to 100 μm, from 5 μm to 10 μm, from 5 μm to 50 μm, from 5 μm to 100 μm, from 10 μm to 50 μm, from 10 μm to 100 μm, or from 50 μm to 100 μm. Optionally, the conductive protection layer may have a thickness of from about 1 μm to about 500 μm, such as from 1 μm to 2 μm, from 1 μm to 5 μm, from 1 μm to 10 μm, from 1 μm to 20 μm, from 1 μm to 50 μm, from 1 μm to 100 μm, from 1 μm to 200 μm, from 1 μm to 500 μm, from 2 μm to 5 μm, from 2 μm to 10 μm, from 2 μm to 20 μm, from 2 μm to 50 μm, from 2 μm to 100 μm, from 2 μm to 200 μm, from 2 μm to 500 μm, from 5 μm to 10 μm, from 5 μm to 20 μm, from 5 μm to 50 μm, from 5 μm to 100 μm, from 5 μm to 200 μm, from 5 μm to 500 μm, from 10 μm to 20 μm, from 10 μm to 50 μm, from 10 μm to 100 μm, from 10 μm to 200 μm, from 10 μm to 500 μm, from 20 μm to 50 μm, from 20 μm to 100 μm, from 20 μm to 200 μm, from 20 μm to 500 μm, from 50 μm to 100 μm, from 50 μm to 200 μm, from 50 μm to 500 μm, from 100 μm to 200 μm, from 100 μm to 500 μm, or from 200 μm to 500 μm.

Aluminum alloys may be useful as a component of the substrates provided herein. In some cases, aluminum alloys may be advantageous because such material may exhibit good electronic conductivity, weight, and other materials properties (e.g., strength, malleability, etc.). Despite these advantages, aluminum alloys are generally not used as anode current collectors in current state of the art lithium ion batteries because aluminum can be corroded, alloyed, or otherwise damaged or destroyed under anode conditions in a lithium ion battery.

However, in the present disclosure, aluminum alloys can be used. In some examples, the aluminum alloy layer may comprise an aluminum alloy sheet or an aluminum alloy foil. The aluminum alloy layer may have any suitable thickness or lateral dimensions. In some cases relatively thin products like aluminum alloy sheets or aluminum alloy foils may be used or even preferred versus thicker products like aluminum alloy sheets or aluminum alloy plates, since these thicker products may not provide for significantly better electrical conductivity than a sheet or foil but will occupy more space and have more weight. In some cases, however, aluminum alloy plates or aluminum alloy sheets may be used for the aluminum alloy layer. In some examples, the aluminum alloy layer may have a thickness of from about 1 μm to about 500 μm, such as from 1 μm to 2 μm, from 1 μm to 5 μm, from 1 μm to 10 μm, from 1 μm to 20 μm, from 1 μm to 50 μm, from 1 μm to 100 μm, from 1 μm to 200 μm, from 1 μm to 500 μm, from 2 μm to 5 μm, from 2 μm to 10 μm, from 2 μm to 20 μm, from 2 μm to 50 μm, from 2 μm to 100 μm, from 2 μm to 200 μm, from 2 μm to 500 μm, from 5 μm to 10 μm, from 5 μm to 20 μm, from 5 μm to 50 μm, from 5 μm to 100 μm, from 5 μm to 200 μm, from 5 μm to 500 μm, from 10 μm to 20 μm, from 10 μm to 50 μm, from 10 μm to 100 μm, from 10 μm to 200 μm, from 10 μm to 500 μm, from 20 μm to 50 μm, from 20 μm to 100 μm, from 20 μm to 200 μm, from 20 μm to 500 μm, from 50 μm to 100 μm, from 50 μm to 200 μm, from 50 μm to 500 μm, from 100 μm to 200 μm, from 100 μm to 500 μm, or from 200 μm to 500 μm. Optionally, the aluminum alloy layer may have a thickness of from about 10 nm to about 100 μm, such as from 10 nm to 50 nm, from 10 nm to 100 nm, from 10 nm to 1 μm, from 10 nm to 5 μm, from 10 nm to 10 μm, from 10 nm to 50 μm, from 10 nm to 100 μm, from 50 nm to 100 nm, from 50 nm to 500 nm, from 50 nm to 1 μm, from 50 nm to 5 μm, from 50 nm to 10 μm, from 50 nm to 50 μm, from 50 nm to 100 μm, from 100 nm to 500 nm, from 100 nm to 1 μm, from 100 nm to 5 μm, from 100 nm to 10 μm, from 100 nm to 50 μm, from 100 nm to 100 μm, from 500 nm to 1 μm, from 500 nm to 5 μm, from 500 nm to 10 μm, from 500 nm to 50 μm, from 500 nm to 100 μm, from 1 μm to 5 μm, from 1 μm to 10 μm, from 1 μm to 50 μm, from 1 μm to 100 μm, from 5 μm to 10 μm, from 5 μm to 50 μm, from 5 μm to 100 μm, from 10 μm to 50 μm, from 10 μm to 100 μm, or from 50 μm to 100 μm.

In some cases the conductive protection layer may comprise a first foil and the aluminum alloy layer may comprise a second foil, such as where the first foil and the second foil are bonded to one another.

In embodiments, the substrate may comprise or correspond to an electronic substrate. In embodiments, the substrate may comprise or correspond to a current collector. In embodiments, the substrate may comprise or correspond to a current collector for an electrochemical cell, a capacitor, or a supercapacitor. In embodiments, the substrate may comprise or correspond to a current collector for a lithium ion electrochemical cell. In embodiments, the substrate may comprise or correspond to an anode current collector or a cathode current collector.

Devices are also described herein, such as a device comprising a substrate, such as any of those substrates described herein. In some examples, a device comprises: an aluminum alloy layer, such as an aluminum alloy layer corresponding to a current collector for an electrode; a conductive protection layer in contact with the aluminum alloy layer; and an electrode active material in contact with the conductive protection layer. Such a device may comprise or correspond to an electrochemical cell electrode. Optionally, electrode active material comprises a lithium ion cathode active material or a lithium ion anode active material. Optionally, the device may comprise or correspond to an electrochemical cell or a battery.

In some examples, the aluminum alloy layer, the conductive protection layer, and the electrode active material comprise or correspond to a first electrochemical cell electrode, and the device may further comprise a second electrochemical cell electrode and an electrolyte positioned between the first electrochemical cell electrode and the second electrochemical cell electrode. In this way, the device may optionally correspond to an electrochemical cell.

Optionally, the device may further comprise electronic device circuitry in direct or indirect electrical communication with and drawing or receiving current from the first electrochemical cell electrode or the second electrochemical cell electrode. For example, the device may comprise or correspond to a portable electronic device.

In another aspect, methods are described herein, such as methods for making substrates, current collectors, electrodes, or electrochemical cells. An example method of this aspect comprises providing an aluminum alloy layer; and contacting the aluminum alloy layer with a conductive protection layer or providing a conductive protection layer; and contacting the conductive protection layer with an aluminum alloy layer. Contacting may comprise depositing the conductive protection layer or the aluminum alloy layer using one or more of a physical deposition process, a sputter deposition process, an evaporation deposition process, a chemical deposition process, an electrodeposition process, an electroplating process, a chemical vapor deposition process, or an atomic layer deposition process. In some cases, contacting may comprise multiple separate coating processes, such as a first coating process and a second coating process, which may be the same or different. In one example, the first coating process may comprise an evaporative deposition process and the second coating process may comprise a sputter deposition process. In another example, the first coating process may comprise a sputter deposition process and the second coating process may comprise an evaporative deposition process. Such techniques may be useful for forming the conductive protection layer as a coating on an aluminum alloy layer comprising an aluminum alloy foil or forming the aluminum alloy layer as a coating on a conductive protection layer comprising a metal or metal alloy foil. In one example, the conductive protection layer comprises a first foil and the aluminum alloy layer comprises a second foil and contacting may comprise bonding the first foil and the second foil.

In some examples, the conductive protection layer comprises a composite structure. In some examples, coating the aluminum alloy layer comprises: depositing a first sub-layer on the aluminum alloy layer; and depositing a second sub-layer on the first sub-layer.

Substrates made by the methods of this aspect may include any of the substrates described herein.

Other objects and advantages will be apparent from the following detailed description of non-limiting examples.

### BRIEF DESCRIPTION OF THE FIGURES

The specification makes reference to the following appended figures, in which use of like reference numerals in different figures is intended to illustrate like or analogous components.

FIG. 1A and FIG. 1B provide schematic cross-sectional illustrations of example substrates comprising an aluminum alloy layer and a conductive protection layer.

FIG. 2A and FIG. 2B provide schematic cross-sectional illustrations of example substrates comprising an aluminum alloy layer and a conductive protection layer with a composite structure.

FIG. 3 provides a schematic cross-sectional illustration of an example electrochemical cell electrode.

FIG. 4A and FIG. 4B provide a schematic cross-sectional illustrations of example electrochemical cells.

FIG. 5A, FIG. 5B, and FIG. 5C provide cyclic voltammograms of lithium half cells using different materials as conductive protection layers on aluminum foil as a working electrode.

FIG. 6 provides data and photographs showing the behavior of the Fe protection layer on Al compared to Cu and bare Al, according to some examples.

FIG. 7 provides scanning electron microscopy images of sputtered Fe films before and after electrochemical testing, according to some examples.

FIG. 8 shows a flooded cell configuration, cell photographs, and data showing current and charge density evolution, according to some examples.

FIG. 9 provides data and a photograph showing the effect of epoxy on current density evolution in various electrochemical cells, according some examples.

### DETAILED DESCRIPTION

Described herein are substrates including a layer of an aluminum alloy in contact with a conductive coating or protective overlayer, which can prevent certain material from coming into contact with the aluminum alloy layer. The substrates may be used, for example, in electronics applications, such as current collectors or electrodes for batteries, electrochemical cells, capacitors, supercapacitors, or the like.

In the context of lithium or lithium ion batteries, aluminum is commonly used as a current collector on the cathode side. Despite the lighter weight, lower cost, and good conductivity of aluminum, copper is typically used as a current collector on the anode side. Generally, copper is used as a current collector on the anode side because copper is generally non-reactive at the anode potentials and provides good conductivity. Aluminum, on the other hand, can be reactive at the potentials common on the anode side, resulting in the alloying of the aluminum by lithium, which degrades or damages such an aluminum anode current collector to a level that would render a battery with an aluminum anode current collector inoperable. In some cases, aluminum used as a cathode current collector can suffer from some corrosion or degradation, though typically in low amounts that may not impact the operability of a battery.

Despite these difficulties, aluminum can be used as a current collector on the cathode side of an electrochemical cell as well as the anode side. Aluminum current collectors are achievable by providing a conductive protection layer over the aluminum, preventing or blocking the aluminum from coming into contact with lithium at the anode active material or otherwise preventing or limiting corrosion, degradation, or alloying of the aluminum layer while reducing weight and achieving good overall stability and cyclability.

### Definitions and Descriptions

As used herein, the terms “invention,” “the invention,” “this invention” and “the present invention” are intended to refer broadly to all of the subject matter of this patent application and the claims below. Statements containing these terms should be understood not to limit the subject matter described herein or to limit the meaning or scope of the patent claims below.

In this description, reference may be made to alloys identified by AA numbers and other related designations, such as “series” or “1xxx.” For an understanding of the number designation system most commonly used in naming and identifying aluminum and its alloys, see “International Alloy Designations and Chemical Composition Limits for Wrought Aluminum and Wrought Aluminum Alloys” or “Registration Record of Aluminum Association Alloy Designations and Chemical Compositions Limits for Aluminum Alloys in the Form of Castings and Ingot,” both published by The Aluminum Association.

As used herein, a plate generally has a thickness of greater than about 15 mm. For example, a plate may refer to an aluminum product having a thickness of greater than about 15 mm, greater than about 20 mm, greater than about 25 mm, greater than about 30 mm, greater than about 35 mm, greater than about 40 mm, greater than about 45 mm, greater than about 50 mm, or greater than about 100 mm.

As used herein, a shate (also referred to as a sheet plate) generally has a thickness of from about 4 mm to about 15 mm. For example, a shate may have a thickness of about 4 mm, about 5 mm, about 6 mm, about 7 mm, about 8 mm, about 9 mm, about 10 mm, about 11 mm, about 12 mm, about 13 mm, about 14 mm, or about 15 mm.

As used herein, a sheet generally refers to an aluminum alloy product having a thickness of less than about 4 mm. For example, a sheet may have a thickness of less than about 4 mm, less than about 3 mm, less than about 2 mm, less than about 1 mm, less than about 0.5 mm, or less than about 0.3 mm (e.g., about 0.2 mm). The term sheet also encompasses aluminum alloy products that may be referred to as foils, which may have a thickness of up to 500 μm, such as from about 1μm to about 500 μm, for example.

As used herein, terms such as “cast metal product,” “cast product,” “cast aluminum alloy product,” and the like are interchangeable and refer to a product produced by direct chill casting (including direct chill co-casting) or semi-continuous casting, continuous casting (including, for example, by use of a twin belt caster, a twin roll caster, a block caster, or any other continuous caster), electromagnetic casting, hot top casting, or any other casting method.

All ranges disclosed herein are to be understood to encompass any and all subranges subsumed therein. For example, a stated range of “1 to 10” should be considered to include any and all subranges between (and inclusive of) the minimum value of 1 and the maximum value of 10; that is, all subranges beginning with a minimum value of 1 or more, e.g. 1 to 6.1, and ending with a maximum value of 10 or less, e.g., 5.5 to 10. Unless stated otherwise, the expression “up to” when referring to the compositional amount of an element means that element is optional and includes a zero percent composition of that particular element. Unless stated otherwise, all compositional percentages are in weight percent (wt. %).

As used herein, the meaning of “a,” “an,” and “the” includes singular and plural references unless the context clearly dictates otherwise.

### Methods of Producing Aluminum Alloy Products

The aluminum alloy products described herein, such as aluminum sheet metal and aluminum foils, can be prepared by casting using any suitable casting method known to those of skill in the art. As a few non-limiting examples, the casting process can include a direct chill (DC) casting process or a continuous casting (CC) process. The continuous casting system can include a pair of moving opposed casting surfaces (e.g., moving opposed belts, rolls or blocks), a casting cavity between the pair of moving opposed casting surfaces, and a molten metal injector. The molten metal injector can have an end opening from which molten metal can exit the molten metal injector and be injected into the casting cavity.

A cast ingot, cast slab, or other cast product can be processed by any suitable means. Such processing steps include, but are not limited to, homogenization, hot rolling, cold rolling, solution heat treatment, and an optional pre-aging step.

Briefly, in a homogenization step, a cast product is heated to a temperature ranging from about 400° C. to about 550° C. For example, the cast product can be heated to a temperature of about 400° C., about 410° C., about 420° C., about 430° C., about 440° C., about 450° C., about 460° C., about 470° C., about 480° C., about 490° C., or about 500° C. The product is then allowed to soak (i.e., held at the indicated temperature) for a period of time to form a homogenized product. In some examples, the total time for the homogenization step, including the heating and soaking phases, can be up to 24 hours. For example, the product can be heated up to 500° C. and soaked, for a total time of up to 18 hours for the homogenization step.

Following a homogenization step, a hot rolling step can be performed. Prior to the start of hot rolling, the homogenized product can be allowed to cool to a temperature between 300° C. to 450° C. For example, the homogenized product can be allowed to cool to a temperature of between 325° C. to 425° C. or from 350° C. to 400° C. The homogenized product can then be hot rolled at a temperature between 300° C. to 500° C. to form a hot rolled plate, a hot rolled shate or a hot rolled sheet having a gauge between 3 mm and 200 mm (e.g., 3 mm, 4 mm, 5 mm, 6 mm, 7 mm, 8 mm, 9 mm, 10 mm, 15 mm, 20 mm, 25 mm, 30 mm, 35 mm, 40 mm, 45 mm, 50 mm, 55 mm, 60 mm, 65 mm, 70 mm, 75 mm, 80 mm, 85 mm, 90 mm, 95 mm, 100 mm, 110 mm, 120 mm, 130 mm, 140 mm, 150 mm, 160 mm, 170 mm, 180 mm, 190 mm, 200 mm, or anywhere in between).

Optionally, the cast product can be a continuously cast product that can be allowed to cool to a temperature between 300° C. to 450° C. For example, the continuously cast product can be allowed to cool to a temperature of between 325° C. to 425° C. or from 350° C. to 400° C. The continuously cast products can then be hot rolled at a temperature between 300° C. to 500° C. to form a hot rolled plate, a hot rolled shate or a hot rolled sheet having a gauge between 3 mm and 200 mm (e.g., 3 mm, 4 mm, 5 mm, 6 mm, 7 mm, 8 mm, 9 mm, 10 mm, 15 mm, 20 mm, 25 mm, 30 mm, 35 mm, 40 mm, 45 mm, 50 mm, 55 mm, 60 mm, 65 mm, 70 mm, 75 mm, 80 mm, 85 mm, 90 mm, 95 mm, 100 mm, 110 mm, 120 mm, 130 mm, 140 mm, 150 mm, 160 mm, 170 mm, 180 mm, 190 mm, 200 mm, or anywhere in between). During hot rolling, temperatures and other operating parameters can be controlled so that the temperature of the hot rolled intermediate product upon exit from the hot rolling mill is no more than 470° C., no more than 450° C., no more than 440° C., or no more than 430° C.

Cast, homogenized, or hot-rolled products can be cold rolled using cold rolling mills into thinner products, such as a cold rolled sheet. The cold rolled product can have a gauge between about 0.1 mm to 10 mm, e.g., between about 0.7 mm to 6.5 mm. Optionally, the cold rolled product can have a gauge of 0.2 mm, 0.5 mm, 1.0 mm, 1.5 mm, 2.0 mm, 2.5 mm, 3.0 mm, 3.5 mm, 4.0 mm, 4.5 mm, 5.0 mm, 5.5 mm, 6.0 mm, 6.5 mm, 7.0 mm, 7.5 mm, 8.0 mm, 8.5 mm, 9.0 mm, 9.5 mm, or 10.0 mm. In the case of foils, the cold rolled sheet can have a gauge of from about 1 μm to 500 μm, such as from 10 μm to 100 μm. The cold rolling can be performed to result in a final gauge thickness that represents a gauge reduction of up to 85% (e.g., up to 10%, up to 20%, up to 30%, up to 40%, up to 50%, up to 60%, up to 70%, up to 80%, or up to 85% reduction) or more as compared to a gauge prior to the start of cold rolling.

In some cases, a heat treatment process can follow a cold rolling process. For example, a heat treatment process may include heating a rolled product to a temperature of from about 300° C. to about 450° C. Once the rolled product reaches the desired heat treatment temperature, it may be soaked or held at the target temperature for a specific duration, such as from about 0.5 hours to about 6 hours. Such a heat treatment process may be distinct from a solution heat treatment process, described below.

For preparation of foil, a small gauge can be achieved during cold rolling, such as about 0.2 mm, followed by a separate foil rolling process, where the cold rolled product can be rolled to a gauge of from about 1 μm to about 300 μ.m (e.g., 0.001 mm to 0.30 mm). In some examples, a foil may be rolled using a foil rolling process to a gauge of 1 μm, 1.5 μm, 2 μm, 2.5 μm, 3 μm, 3.5 μm, 4 μm, 4.5 μm, 5 μm, 5.5 μm, 6 μm, 6.5 μm, 7 μm, 7.5 μm, 8 μm, 8.5 μm, 9 μm, 9.5 μm, from 10 μm to 50 μm, from 50 μm to 100 μm, from 100 μm to 150 μm, from 150 μm to 200 μm, from 200 μm to 250 μm, or from 250 μm to 300 μm.

In some examples, a cast, homogenized, or rolled product can undergo a solution heat treatment step. The solution heat treatment step can be any suitable treatment for the sheet which results in solutionizing of the soluble particles. The cast, homogenized, or rolled product can be heated to a peak metal temperature (PMT) of up to 590° C. (e.g., from 400° C. to 590° C.) and soaked for a period of time at the PMT to form a hot product. For example, the cast, homogenized, or rolled product can be soaked at 480° C. for a soak time of up to 30 minutes (e.g., 0 seconds, 60 seconds, 75 seconds, 90 seconds, 5 minutes, 10 minutes, 20 minutes, 25 minutes, or 30 minutes). After heating and soaking, the hot product is rapidly cooled at rates greater than 200° C./s to a temperature between 500 and 200° C. to form a heat-treated product. In one example, the hot product is cooled at a quench rate of above 200° C./second at temperatures between 450° C. and 200° C. Optionally, the cooling rates can be faster in other cases.

After quenching, the heat-treated product can optionally undergo a pre-aging treatment by reheating before coiling. The pre-aging treatment can be performed at a temperature of from about 70° C. to about 125° C. for a period of time of up to 6 hours. For example, the pre-aging treatment can be performed at a temperature of about 70° C., about 75° C., about 80° C., about 85° C., about 90° C., about 95° C., about 100° C., about 105° C., about 110° C., about 115° C., about 120° C., or about 125° C. Optionally, the pre-aging treatment can be performed for about 30 minutes, about 1 hour, about 2 hours, about 3 hours, about 4 hours, about 5 hours, or about 6 hours. The pre-aging treatment can be carried out by passing the heat-treated product through a heating device, such as a device that emits radiant heat, convective heat, induction heat, infrared heat, or the like.

### Methods of Using the Disclosed Aluminum Alloy Products

The aluminum alloy products described herein can be used in electronics applications. For example, the aluminum alloy products and methods described herein can be used to prepare components for electronic devices, including batteries, mobile phones, and tablet computers. In some examples, the aluminum alloy products can be used to prepare current collectors and electrodes used in electrochemical cells, capacitors, or batteries, which can be used in mobile phones, tablet computers, or the like.

### Metal Alloys

Described herein are methods of treating aluminum alloys and the resultant treated aluminum alloys. In some examples, the aluminum alloys for use in the methods described herein can include 1xxx series aluminum alloys, 2xxx series aluminum alloys, 3xxx series aluminum alloys, 4xxx series aluminum alloys, 5xxx series aluminum alloys, 6xxx series aluminum alloys, 7xxx series aluminum alloys, or 8xxx series aluminum alloys.

By way of non-limiting example, exemplary 1xxx series aluminum alloys can include AA1100, AA1100A, AA1200, AA1200A, AA1300, AA1110, AA1120, AA1230, AA1230A, AA1235, AA1435, AA1145, AA1345, AA1445, AA1150, AA1350, AA1350A, AA1450, AA1370, AA1275, AA1185, AA1285, AA1385, AA1188, AA1190, AA1290, AA1193, AA1198, or AA1199.

Non-limiting exemplary 2xxx series aluminum alloys can include AA2001, A2002, AA2004, AA2005, AA2006, AA2007, AA2007A, AA2007B, AA2008, AA2009, AA2010, AA2011, AA2011A, AA2111, AA2111A, AA2111B, AA2012, AA2013, AA2014, AA2014A, AA2214, AA2015, AA2016, AA2017, AA2017A, AA2117, AA2018, AA2218, AA2618, AA2618A, AA2219, AA2319, AA2419, AA2519, AA2021, AA2022, AA2023, AA2024, AA2024A, AA2124, AA2224, AA2224A, AA2324, AA2424, AA2524, AA2624, AA2724, AA2824, AA2025, AA2026, AA2027, AA2028, AA2028A, AA2028B, AA2028C, AA2029, AA2030, AA2031, AA2032, AA2034, AA2036, AA2037, AA2038, AA2039, AA2139, AA2040, AA2041, AA2044, AA2045, AA2050, AA2055, AA2056, AA2060, AA2065, AA2070, AA2076, AA2090, AA2091, AA2094, AA2095, AA2195, AA2295, AA2196, AA2296, AA2097, AA2197, AA2297, AA2397, AA2098, AA2198, AA2099, or AA2199.

Non-limiting exemplary 3xxx series aluminum alloys can include AA3002, AA3102, AA3003, AA3103, AA3103A, AA3103B, AA3203, AA3403, AA3004, AA3004A, AA3104, AA3204, AA3304, AA3005, AA3005A, AA3105, AA3105A, AA3105B, AA3007, AA3107, AA3207, AA3207A, AA3307, AA3009, AA3010, AA3110, AA3011, AA3012, AA3012A, AA3013, AA3014, AA3015, AA3016, AA3017, AA3019, AA3020, AA3021, AA3025, AA3026, AA3030, AA3130, or AA3065.

Non-limiting exemplary 4xxx series aluminum alloys can include AA4004, AA4104, AA4006, AA4007, AA4008, AA4009, AA4010, AA4013, AA4014, AA4015, AA4015A, AA4115, AA4016, AA4017, AA4018, AA4019, AA4020, AA4021, AA4026, AA4032, AA4043, AA4043A, AA4143, AA4343, AA4643, AA4943, AA4044, AA4045, AA4145, AA4145A, AA4046, AA4047, AA4047A, or AA4147.

Non-limiting exemplary 5xxx series aluminum alloys can include AA5182, AA5183, AA5005, AA5005A, AA5205, AA5305, AA5505, AA5605, AA5006, AA5106, AA5010, AA5110, AA5110A, AA5210, AA5310, AA5016, AA5017, AA5018, AA5018A, AA5019, AA5019A, AA5119, AA5119A, AA5021, AA5022, AA5023, AA5024, AA5026, AA5027, AA5028, AA5040, AA5140, AA5041, AA5042, AA5043, AA5049, AA5149, AA5249, AA5349, AA5449, AA5449A, AA5050, AA5050A, AA5050C, AA5150, AA5051, AA5051A, AA5151, AA5251, AA5251A, AA5351, AA5451, AA5052, AA5252, AA5352, AA5154, AA5154A, AA5154B, AA5154C, AA5254, AA5354, AA5454, AA5554, AA5654, AA5654A, AA5754, AA5854, AA5954, AA5056, AA5356, AA5356A, AA5456, AA5456A, AA5456B, AA5556, AA5556A, AA5556B, AA5556C, AA5257, AA5457, AA5557, AA5657, AA5058, AA5059, AA5070, AA5180, AA5180A, AA5082, AA5182, AA5083, AA5183, AA5183A, AA5283, AA5283A, AA5283B, AA5383, AA5483, AA5086, AA5186, AA5087, AA5187, or AA5088.

Non-limiting exemplary 6xxx series aluminum alloys can include AA6101, AA6101A, AA6101B, AA6201, AA6201A, AA6401, AA6501, AA6002, AA6003, AA6103, AA6005, AA6005A, AA6005B, AA6005C, AA6105, AA6205, AA6305, AA6006, AA6106, AA6206, AA6306, AA6008, AA6009, AA6010, AA6110, AA6110A, AA6011, AA6111, AA6012, AA6012A, AA6013, AA6113, AA6014, AA6015, AA6016, AA6016A, AA6116, AA6018, AA6019, AA6020, AA6021, AA6022, AA6023, AA6024, AA6025, AA6026, AA6027, AA6028, AA6031, AA6032, AA6033, AA6040, AA6041, AA6042, AA6043, AA6151, AA6351, AA6351A, AA6451, AA6951, AA6053, AA6055, AA6056, AA6156, AA6060, AA6160, AA6260, AA6360, AA6460, AA6460B, AA6560, AA6660, AA6061, AA6061A, AA6261, AA6361, AA6162, AA6262, AA6262A, AA6063, AA6063A, AA6463, AA6463A, AA6763, A6963, AA6064, AA6064A, AA6065, AA6066, AA6068, AA6069, AA6070, AA6081, AA6181, AA6181A, AA6082, AA6082A, AA6182, AA6091, or AA6092.

Non-limiting exemplary 7xxx series aluminum alloys can include AA7011, AA7019, AA7020, AA7021, AA7039, AA7072, AA7075, AA7085, AA7108, AA7108A, AA7015, AA7017, AA7018, AA7019A, AA7024, AA7025, AA7028, AA7030, AA7031, AA7033, AA7035, AA7035A, AA7046, AA7046A, AA7003, AA7004, AA7005, AA7009, AA7010, AA7011, AA7012, AA7014, AA7016, AA7116, AA7122, AA7023, AA7026, AA7029, AA7129, AA7229, AA7032, AA7033, AA7034, AA7036, AA7136, AA7037, AA7040, AA7140, AA7041, AA7049, AA7049A, AA7149,7204, AA7249, AA7349, AA7449, AA7050, AA7050A, AA7150, AA7250, AA7055, AA7155, AA7255, AA7056, AA7060, AA7064, AA7065, AA7068, AA7168, AA7175, AA7475, AA7076, AA7178, AA7278, AA7278A, AA7081, AA7181, AA7185, AA7090, AA7093, AA7095, or AA7099.

Non-limiting exemplary 8xxx series aluminum alloys can include AA8005, AA8006, AA8007, AA8008, AA8010, AA8011, AA8011A, AA8111, AA8211, AA8112, AA8014, AA8015, AA8016, AA8017, AA8018, AA8019, AA8021, AA8021A, AA8021B, AA8022, AA8023, AA8024, AA8025, AA8026, AA8030, AA8130, AA8040, AA8050, AA8150, AA8076, AA8076A, AA8176, AA8077, AA8177, AA8079, AA8090, AA8091, or AA8093.

### Substrates

The aluminum alloy products, such as foils, sheets, or coatings, described herein can be used to make substrates, such as electronic substrates, which may be suitable for use in applications as a current collector or a device incorporating such a current collector, such as an electrode, an electrochemical cell, or a capacitor. In some examples, the aluminum alloy may be provided as a sheet or a foil, but is generally referred to herein as a layer in the context of a substrate. For use as a substrate, the aluminum alloy layer may be coated with or otherwise in contact with a conductive layer, which may also be referred to herein as a protection layer or a conductive protection layer. The aluminum alloy may alternatively be provided as a coating over a conductive protection layer, which may optionally comprise a metal or metal alloy foil. In some cases, both the aluminum alloy and the conductive protection layer may comprise foils.

The conductive layer may be useful for preventing materials from contacting the aluminum alloy layer, such as in current collector applications for electrochemical cells or capacitors. In some examples, the conductive layer may serve to block or otherwise prevent transmission of certain materials, such as to limit contact of those materials with the underlying aluminum alloy layer. In some examples, contacting the aluminum alloy layer with lithium atoms and/or lithium ions may be deleterious, causing corrosion, reaction, and/or alloying of the aluminum alloy with lithium.

Use of aluminum as a current collector for an anode in a lithium or lithium ion battery is generally undesirable because of the corrosion, reaction, and/or alloying that can take place at the anode potential. For example, corrosion or alloying of an aluminum alloy by lithium may result in formation of non-conductive materials, which may hamper or inhibit electrical conduction by an aluminum alloy or degrade an electrical conductivity of the aluminum alloy. However, use of a conductive coating layer can protect the aluminum alloy layer by limiting the contact, corrosion, reaction, and/or alloying of the aluminum alloy layer by lithium or lithium ions, while still allowing for the bulk of transmission of electrical current by the aluminum layer.

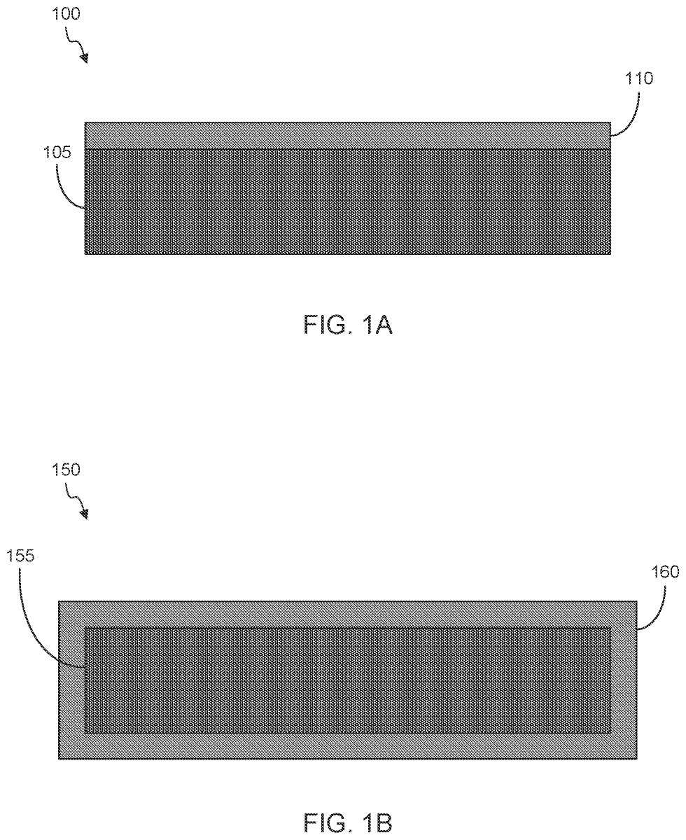

FIG. 1A provides an example of a substrate 100, shown schematically in cross-section, comprising an aluminum alloy layer 105 and a conductive layer 110 coating the aluminum alloy layer 105. In the substrate 100, the conductive layer 110 is shown in contact with only one surface or side of the aluminum alloy layer 105, but other configurations may be used, such as where conductive layer 110 is in contact with different edges, surfaces, or faces of aluminum alloy layer 105.

Several aspects, however, may be optionally useful for conductive protection layers. As an example, the conductive protection layer should be electrically conductive. Example conductive protection layers may have an electrical conductivity of from 10⁵ S/m to 10⁸ S/m or an electrical resistivity of from 10⁻⁸ Ω·m to 10⁻⁶ Ω·m. Such an electrical conductivity or electrical resistivity may be sufficient to permit conduction of electrons through the conductive protection layer to the aluminum alloy layer, where the bulk of conduction can occur.

As another example, it may be beneficial for the conductive protection layer to be free or substantially free of imperfections that allow transmission of lithium atoms or lithium ions to the aluminum alloy layer, such as from a surface of the conductive layer to an internal surface at the interface with or facing the aluminum alloy layer. As used herein, the phrase substantially free refers to cases where an absolute absence of a condition does not exist but for which the absence is not detrimental and does not result in failure, degradation, or lack of usability. For example, a conductive coating layer that is substantially free of imperfections can include some imperfections, but the included imperfections do not inhibit the coating layer from protecting an underlying aluminum alloy layer. Example imperfections may include, but are not limited to, voids, channels, cracks, growth defects, nodular defects, troughs, or crystallographic defects, like dislocations, stacking faults, or grain boundaries. In some cases, imperfections can be filled, covered, or otherwise sealed or effectively removed by depositing a second conductive sub-layer over a first sub-layer including imperfections.

It may also be beneficial for the conductive protection layer to comprise a high purity layer, such as having an amount of impurities of 30 wt. % or less, 25 wt. % or less, 20 wt. % or less, 15 wt. % or less, 10 wt. % or less, 9 wt. % or less, 8 wt. % or less, 7 wt. % or less, 6 wt. % or less, 5 wt. % or less, 4 wt. % or less, 3 wt. % or less, 2 wt. % or less, 1 wt. % or less, 0.1 wt. % or less, or 0.01 wt. % or less.

In some cases when creating conductive coating layers, opportunities for imperfections to be created exist and these imperfections may be minimized, limited, or eliminated to provide little or no pathways for lithium contamination into the underlying aluminum alloy layer. For example, in some techniques for depositing a conductive coating over an aluminum alloy layer, the deposition may occur as vertical columnar type crystal structures, where imperfections that exist at the base of a columnar structure can propagate to significant depths/thicknesses of the deposited material. Limiting these imperfections during fabrication can be useful. In some cases, polycrystalline structures can be formed, which can avoid creation of imperfections that tend to extend throughout a conductive coating. Some example techniques for creating conductive protection layers include, but are not limited to a physical deposition process, a sputter deposition process, an evaporation deposition process, a chemical deposition process, an electrodeposition process, an electroplating process, a chemical vapor deposition process, or an atomic layer deposition process.

In some cases, the imperfections in the conductive protection layer may be reduced or significantly eliminated by using a metal or metal alloy foil as the conductive protection layer and then coating the conductive protection layer with an aluminum alloy coating or bonding the conductive protection layer to an aluminum alloy foil.

A substrate, such as substrate 100, may be created by depositing the conductive layer 110 over only one side the aluminum alloy layer 105. The conductive layer can have any suitable thickness. Example thicknesses may be from about 10 nm to about 100 μm, such as from 10 nm to 50 nm, from 10 nm to 100 nm, from 10 nm to 500 nm, from 10 nm to 1 μm, from 10 nm to 10 μm, from 10 nm to 50 μm, from 10 nm to 100 μm, from 50 nm to 100 nm, from 50 nm to 500 nm, from 50 nm to 1 μm, from 50 nm to 10 μm, from 50 nm to 50 μm, from 50 nm to 100 μm, from 100 nm to 500 nm, from 100 nm to 1 μm, from 100 nm to 5 μm, from 100 nm to 10 μm, from 100 nm to 50 μm, from 100 nm, to 100 μm, from 500 nm to 1 μm, from 500 nm to 5 μm, from 500 nm to 10 μm, from 500 nm to 50 μm, from 500 nm to 100 μm, from 1 μm to 5 μm, from 1 μm to 10 μm, from 1 μm to 50 μm, from 1 μm to 100 μm, from 5 μm to 10 μm, from 5 μm to 50 μm, from 5 μm to 100 μm, from 10 μm to 50 μm, from 10 μm to 100 μm, or from 50 μm to 100 μm.

It may be desirable in some cases to achieve partial or complete encapsulation of an aluminum alloy layer by a conductive layer, such as to limit any potential paths for contacting the aluminum alloy layer with an undesirable substance. Another substrate 150, shown schematically in FIG. 1B in cross-section, may comprise an aluminum alloy layer 155 completely covered by a conductive layer 160. Such a configuration may be achieved, for example, by using a non-directional deposition technique, such as an electrodeposition process, which can be a solution-phase process and result in complete coating or encapsulation of aluminum alloy layer 155 by the conductive layer 160.

Materials useful for the conductive layer may include materials that do not alloy with lithium. Stated another way, it may be useful for the conductive layer to not include materials that alloy with lithium. As examples, it may be useful for the conductive protection layer to lack or not include aluminum, zinc, magnesium, silicon, germanium, tin, indium, antimony, and/or carbon.

Materials useful for the conductive layer may include materials that are non-reactive with lithium at potentials of from 0 V to 5 V vs. Li/Lⁱ⁺. In some cases, when these materials are used or included in a conductive protection layer, such materials may be attacked by lithium atoms or lithium ions and result in lithium atoms or lithium ions reaching the aluminum alloy layer and corroding, alloying with, or otherwise degrading the aluminum alloy layer. Specific materials useful for the conductive protection layer include, but are not limited to titanium, chromium, iron, nickel, molybdenum, tungsten, copper, titanium nitride, or any combination of these. Materials useful for the conductive protection layer include those having a high purity, such as greater than 70 wt. %, greater than 75 wt. %, greater than 80 wt. %, greater than 85 wt. %, greater than 90 wt. %, or greater than 95 wt. %. In some cases, however, the conductive protection layer may comprise or include an alloy or mixture of materials, such as an alloy or mixture of one or more of titanium, chromium, iron, nickel, molybdenum, tungsten, or copper.

In some cases, it may be useful to include a composite structure for the conductive protection layer. For example, a conductive protection layer may include multiple individual sub-layers, such as two or up to 10 or 20 or 100 sub-layers. Each sub-layer may have the same or different compositions from any other sub-layer. Each sub-layer may be generated using the same or different processes as used for any other sub-layer and/or using the same or different material as used for any other sub-layer. In some examples, use of two or more sub-layers may allow one sub-layer to cover up, fill, or otherwise seal imperfections in another sub-layer to reduce, minimize, or limit transmission of undesirable materials from reaching an underlying aluminum alloy layer.

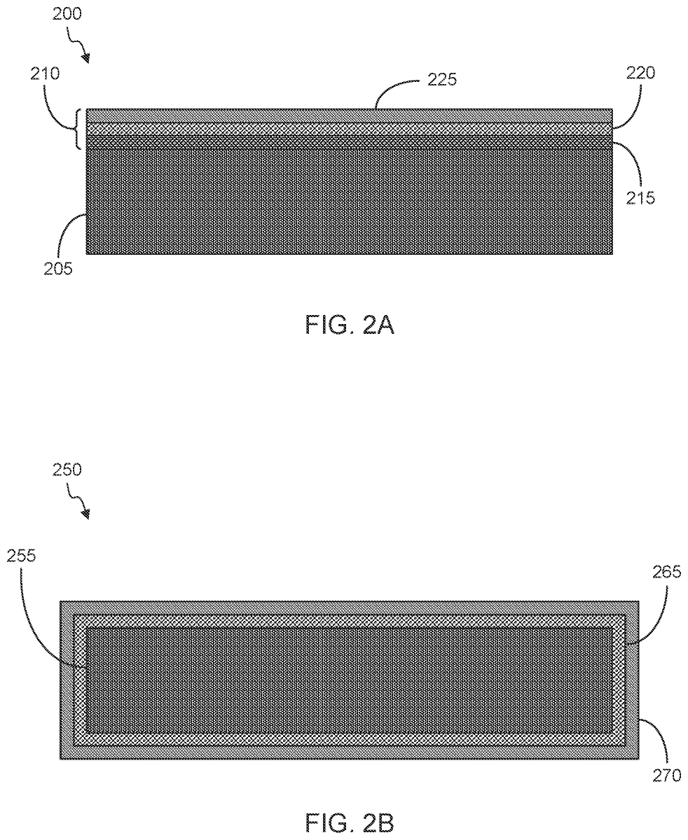

FIG. 2A provides a cross-sectional schematic illustration of another substrate 200, comprising an aluminum alloy layer 205 and a composite conductive layer 210. Composite conductive layer 210 shown in FIG. 2A includes a first sub-layer 215, a second sub-layer 220, and a third sub-layer 225. FIG. 2B provides a cross-sectional schematic illustration of another substrate 250, with aluminum alloy layer 255 completely encapsulated by a composite conductive layer including a first sub-layer 265 and a second sub-layer 270.

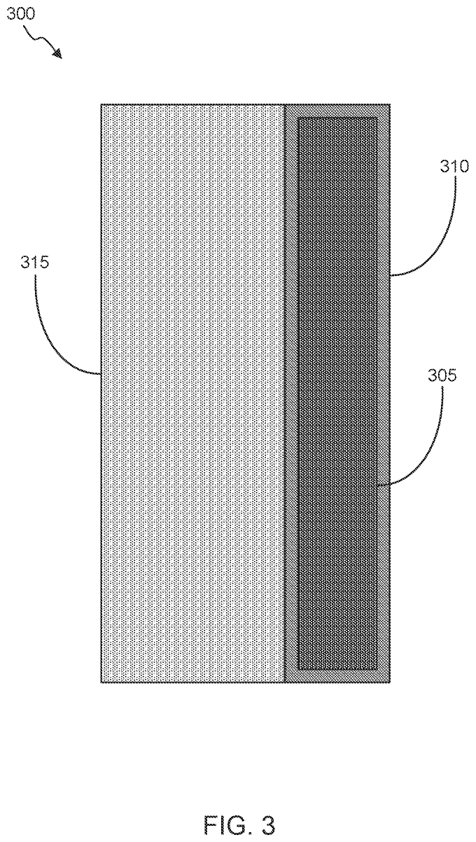

As noted above, the substrates described herein can be used as electronic substrates, such as for current collectors or as electrode components in electrochemical cells and capacitors. FIG. 3 provides a cross-sectional schematic illustration of an example device, corresponding to an electrode 300, which may be a component of an electrochemical cell (e.g., a primary electrochemical cell or a secondary electrochemical cell). Electrode 300 includes an aluminum alloy layer 305, a conductive protection layer 310 and an active material 315. Active material 315 may correspond to the material at which electrochemical reactions take place during charging or discharging of an electrochemical cell. Active material 315 may correspond to a cathode active material or an anode active material in different embodiments. Example materials for electrode active material 315 include lithium ion battery anode active materials, such as intercalation materials, like graphite. In some cases, a metallic lithium anode active material may be used, such as for primary batteries. Example materials for electrode active material 315 include lithium ion battery cathode active materials, such as a lithium-based materials, like lithium cobalt oxide, lithium iron phosphate, lithium manganese oxide, lithium nickel manganese cobalt oxide, lithium nickel cobalt aluminum oxide, or the like.

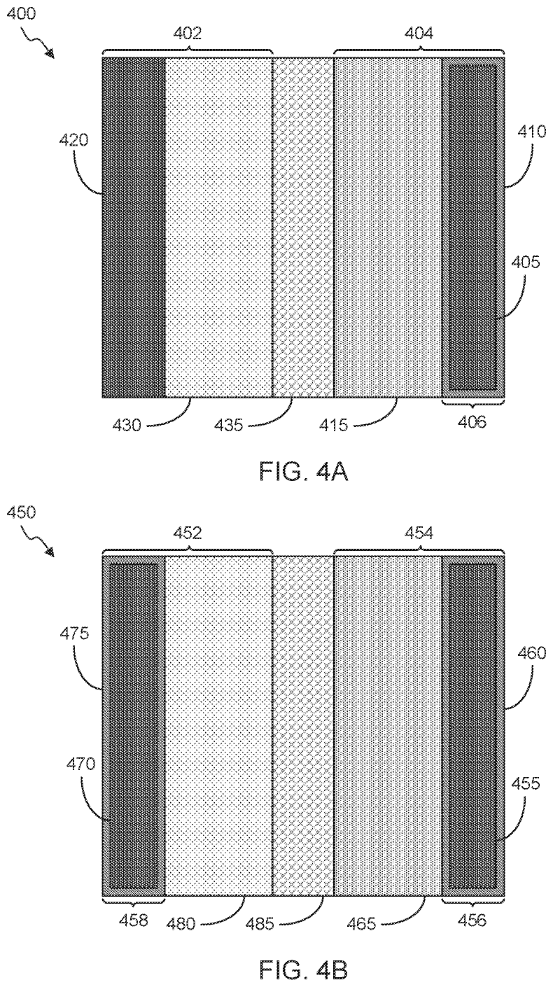

FIG. 4A shows a cross-sectional schematic illustration of an example device, corresponding to an electrochemical cell 400. Electrochemical cell 400 includes a first electrode 402, which may correspond to an anode in some examples, and a second electrode 404, which may correspond to a cathode in some examples. The first electrode 402 of electrochemical cell 400 includes a first current collector 406 comprising an aluminum alloy layer 405 and a conductive protection layer 410. The first electrode 402 of electrochemical cell 400 also includes a first active material 415, such as an anode active material. The second electrode 404 of electrochemical cell 400 includes an aluminum alloy layer 420 (as a second current collector) and a second active material 435, such as a cathode active material. Electrochemical cell 400 also includes a separator and/or an electrolyte, illustrated as component 435. A separator and/or electrolyte are useful for preventing the first electrode active material and the second electrode active material from contacting one another while still allowing ions to be transported across during charging or discharging. Example separators may be or include non-reactive porous materials, such as polymeric membranes like polypropylene, polym(methyl methacrylate), or polyacrylonitrile. Example electrolytes may be or include an organic solvent, such as ethylene carbonate, dimethyl carbonate, or diethyl carbonate, or solid or ceramic electrolytes. Electrolytes may include dissolved lithium salts, such as LiPF₆, LiBF₄, or LiClO₄, and other additives.

FIG. 4B shows a cross-sectional schematic illustration of another example electrochemical cell 450. Electrochemical cell 450 includes a first electrode 452, which may correspond to an anode in some examples, and a second electrode, which may correspond to a cathode in some examples. The first electrode 452 of electrochemical cell 450 includes a first current collector 456 comprising an aluminum alloy layer 455 and a conductive protection layer 460. The first electrode 452 of electrochemical cell 450 also includes a first active material 465, such as an anode active material. The second electrode 454 of electrochemical cell 450 includes a second current collector 458 comprising an aluminum alloy layer 470 and a conductive protection layer 475. The second electrode 452 of electrochemical cell 450 also includes a second active material 480, such as a cathode active material. Electrochemical cell 450 also includes a separator and/or an electrolyte, illustrated as component 485. The aluminum alloy layer 455 of the first current collector 456 may be the same material or a different material (e.g., a different alloy) as the aluminum alloy layer 470 of the second current collector 458. The conductive protection layer 460 of the first current collector 456 may be the same material or a different material as the conductive protection layer 475 of the second current collector 458.

Although the conductive protection layer 410 of current collector 406, the conductive protection layer 460 of first current collector 456, and the conductive protection layer 475 of second current collector 458 are depicted in FIGS. 4A and 4B as a single material, these conductive protection layers instead correspond to a composite structure, such as comprising one or more sub-layers, such as described above and depicted in FIGS. 2A and 2B.

Further, electrochemical cells 400 and 450 may be used in or as components of other devices, such as portable electronic devices, mobile phones, tablet computers, or the like. For example, the first current collector 456 and second current collector 458 of electrochemical cell 450 may be positioned in direct or indirect communication with and receiving or providing current to an electronic device or circuitry of an electronic device.

Contacting an aluminum alloy layer and a conductive protection layer may comprise any suitable process or combination of processes to achieve the substrates described herein. In some examples, as described above, the contacting process may comprise coating an aluminum alloy layer (e.g., an aluminum alloy foil), with a conductive protection layer. Optionally, the contacting process may comprise coating a conductive protection layer (e.g., a metal or metal alloy foil) with an aluminum alloy layer. When the conductive protection layer and the aluminum alloy layer both comprise foils, a bonding process, such as a roll bonding process, may be used to create a strong metallurgical bond between the foils.

The examples disclosed herein will serve to further illustrate aspects of the invention without, at the same time, however, constituting any limitation thereof. On the contrary, it is to be clearly understood that resort may be had to various embodiments, modifications and equivalents thereof which, after reading the description herein, may suggest themselves to those skilled in the art without departing from the spirit of the invention. The examples and embodiments described herein may also make use of conventional procedures, unless otherwise stated. Some of the procedures are described herein for illustrative purposes.

### EXAMPLE 1—ELECTROCHEMICAL CELL TESTS OF HALF-CELLS

To test the effectiveness of different conductive protection layers, half-cells were constructed with an aluminum alloy layer as a working electrode, lithium metal as a counter electrode, and a separator soaked with electrolyte between the aluminum alloy layer and the lithium metal. Various aluminum alloy layers were tested, including an aluminum alloy without a conductive protection layer, and aluminum alloy layers protected with a conductive coating of copper, titanium nitride, or iron having a thickness of about 300 nm.

Cyclic voltammograms were obtained using by controlling the applied voltage or current with a potentiostat to determine which protective layers improve the stability of aluminum alloy as a current collector at low potentials, similar to those at the anode side of a lithium ion electrochemical cell.

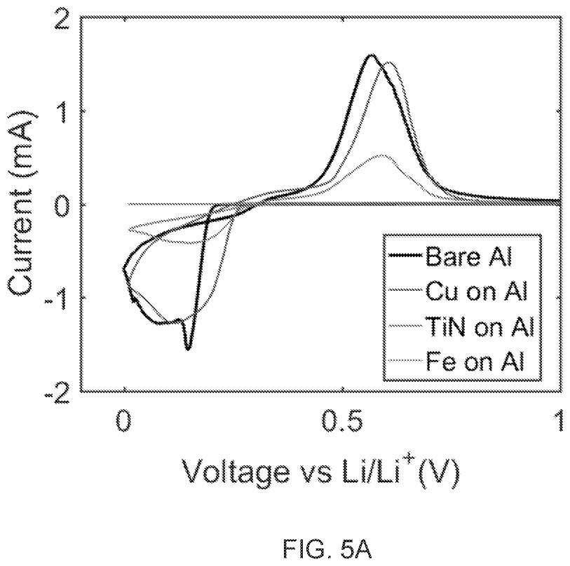

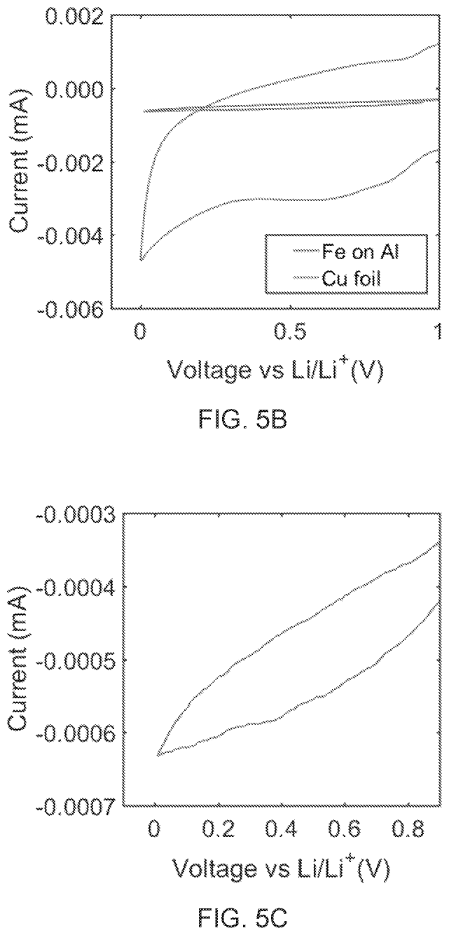

FIG. 5A shows a set of different cyclic voltammograms obtained using the constructed half cells for cycling between 0 V and 1 V vs Li/Li⁺. The magnitude of the current during the sweep from 0 V to 1 V and from 1 V to 0 V reflects the reactivity of lithium with the aluminum alloy working electrode. In FIG. 5A, the line labeled “Bare Al” corresponds to the aluminum alloy electrode with no protective coating, which shows significant reactivity with lithium. Protection by a copper coating (line labeled “Cu on Al”) shows a small change in the protection of the aluminum alloy layer. A greater amount of protection is provided by a titanium nitride coating (line labeled “TiN on Al”). The line labeled “Fe on Al” corresponds to the voltammogram obtained using iron as a conductive protection layer and shows a marked improvement in the reactivity with lithium.

As a comparison, a cyclic voltammogram using a copper foil (line labeled “Cu Foil”) as the working electrode was also obtained, which is shown in FIG. 5B with the iron protected aluminum alloy layer, where the vertical axis is zoomed as compared to FIG. 5A. This shows that the iron coated aluminum alloy layer is considerably less reactive than even a copper foil. FIG. 5C shows a further zoomed view of the cyclic voltammogram of the iron coated aluminum alloy layer.

Further tests of the iron coated aluminum alloy layer and uncoated aluminum alloy layer as working electrodes were performed. Here the working electrodes were held at 10 mV vs Li/Li⁺ to evaluate the reactivity of the working electrode with lithium. In these conditions, the bare aluminum was found to be quite reactive, while the iron coated aluminum alloy layer (Fe protected) was much less reactive.

### EXAMPLE 2

Commercial Li-ion batteries were first introduced by Sony Corporation in 1991 and have become the dominant battery chemistry for consumer electronics and electric vehicles. Immense progress has been made from the first commercial batteries designed in the mid 1980's in order to improve energy density, safety, and cost. The energy density of Li-ion batteries increased steadily at a rate of 10% every year between 1991 and 2005. These improvements were obtained by engineering the anode and cathode materials and optimizing the liquid electrolyte composition. For example, anode materials have changed from hard-carbon to graphite, the composition of the LiCoO₂ cathode material has been engineered by incorporating Ni, Mn, and Al, and the liquid electrolyte composition has been modified with different salts and additives to control SEI formation. Despite these changes in the rest of the battery components, the current collectors of the first intercalation-based rechargeable Li-ion battery described in U.S. Pat. No. 4,668,595 are generally the same standard current collectors used today: 10 μm Cu foil for the anode and 15 μm Al foil for the cathode.

The role of current collectors is to connect the active materials to the external circuit. For this reason, current collectors need to be highly conductive and mechanically robust and adhesive to support the electrode materials. Cu foils are used as the anode current collector due to their electrochemical stability at low potentials vs Li/Li⁺. Al alloys with Li below 0.2 V vs Li/Li⁺, but it is stable at high potentials, so it is used on the cathode side. Electrochemical stability aside, Cu foils cost four times as much as Al foils and are three times denser, so replacing Cu current collectors with Al can reduce the weight and cost of Li-ion batteries. This may provide an overall increase in gravimetric energy density for conventional as well as next-generation Li-based batteries.

The use of Al as the anode current collector in Li-ion batteries has been explored. Given its electrochemical stability window, Al can be used as the anode current collector for higher voltage anode materials such as lithium titanate, which intercalates lithium at 1.5 V vs Li/Li⁺. Another approach has been to use Al as an active metal current collector. The Li—Al alloying reaction has a theoretical capacity of 993 mAh g⁻¹ and a volume expansion of 90%, which limits the cyclability of Al as an anode material.

Extending the stability of Al anode current collectors for commercially relevant periods of time using protection layers is explored in this example. This protection layer should be electrically conductive, should not react with Li, and block lithium diffusion. While Cu may appear to be an obvious candidate, it has been demonstrated that lithium can diffuse into this material when it is used as a current collector. Metals that do not react with lithium include Mo, Nb, Ti, Ni, Cr, or Fe. In the case of Fe, Li diffusion may be extremely sluggish.

This example tests whether an electrically conductive thin film that does not react with lithium and blocks lithium diffusion, such as Fe, can prevent the alloying reaction between Li⁺ and Al in anode current collectors. Potentiostatic holds at 10 mV vs Li/Li⁺ are used to simulate the electrochemical environment of fully charged batteries. These tests reveal that sub-micron thick Fe films extend the stability of Al anode current collectors to hundreds of hours with current densities comparable to copper anode current collectors, the incumbent technology. Implementing these new materials in commercial batteries may be useful for improving weight of the cells, which can result in an improvement in the overall gravimetric capacity.

Methods. Sample Preparation: The Al foil substrates were 15 μm in thickness. Prior to sputtering, the foils were secured on a stainless steel or glass slide by means of adhesive tape. The Al foils used had two distinct sides, one more lustrous than the other. In all cases, the Fe films were sputtered on the more lustrous side. For constructing coin cells, the Al foils were secured on stainless steel spacers (1.55 cm in diameter) using double-sided conductive carbon tape. The area of the foil, tape and stainless steel spacer were approximately the same. In the case of flooded cells, strips of Al foil were taped onto glass slides using double-sided kapton tape of the same width as the Al strips. The Al strips were longer than the glass slide onto which they were taped in order to make electrical connections. After securing the foils, they were pressed firmly against the tape with compressed nitrogen in order to ensure a flat surface. Immediately before loading the samples in the sputterer, the samples were rinsed with isopropyl alcohol and dried with nitrogen.

Sputtering: Fe films were sputtered on Al foil substrates using DC magnetron sputtering.

Cell Construction: Electrochemical cells were constructed using metallic Li as counter and reference electrode, a 1.0 M solution of lithium hexafluorophosphate in ethylene carbonate and diethyl carbonate (1:1 volume ratio, Sigma) as electrolyte, and the test foil as working electrode. Two types of cell were used: coin cells and flooded cells. CR2032 coin cells were constructed in a dry Ar glove box with the following stack order inside the stainless steel case: stainless steel spring, test foil, celgard separator soaked in electrolyte, Li metal electrode. In the case of Fe-protected Al foils, the sputtered foils were stored in the same Ar glove box less than 1 h after sputtering. The Li metal electrode was typically a disk small enough to fit in the coin cell, with a celgard separator. The separator was placed away from the edges of the foil, and the Li electrode was placed in the center of the separator.

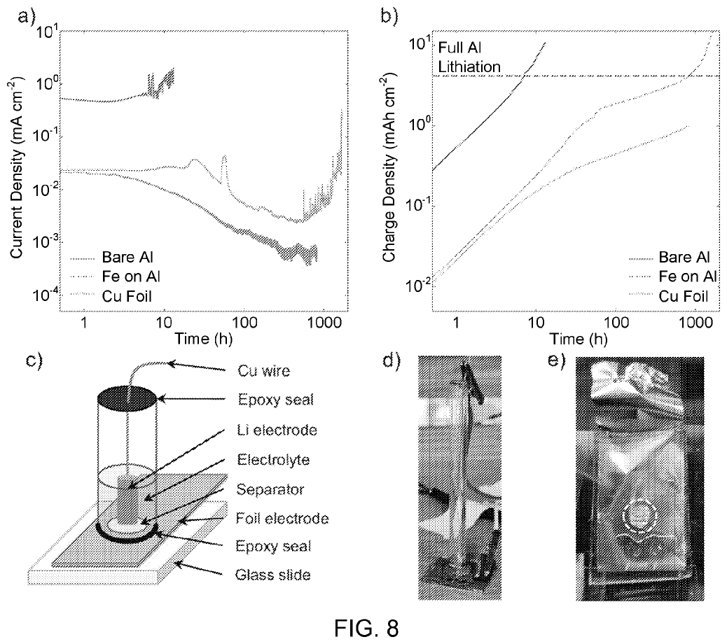

Flooded cells were constructed as depicted in FIG. 8, Panel c. Quartz tubes were adhered to the test foil using epoxy and cured in ambient air at room temperature for ˜12 h before a second layer was applied and cured in the same conditions. After this, the cell was brought into the glovebox. Small squares of glass fiber were placed inside the quartz tube to cover the exposed area of the test foil. After this, a suitable volume of electrolyte was pipetted into the tube. The Li metal electrode was cut into pieces, polished, and wrapped around the end of a Cu wire, covering its tip completely. The Cu wire was inserted into the quartz tube ensuring that the Li metal electrode was pressed against the glass fiber separator and fully submerged in the electrolyte. The other end of the Cu wire extended past the opening of the quartz tube. The cell was finally sealed with the same epoxy inside the glovebox and cured at room temperature for at least 12 h before electrochemical testing. The area used for calculating the current density of each experiment with flooded cells was the exposed area of the test foil at the bottom of the cell.

Electrochemical Testing: All cells underwent linear sweep voltammetry followed by potentiostatic holds at room temperature. The rate of the linear sweep voltammetry was 0.1 mV s⁻¹ from open circuit potential to 10 mV. The voltage was subsequently held at 10 mV until failure.

Surface Characterization: Scanning electron microscopy (SEM) as well as X-ray photoelectron spectroscopy (XPS) were used to probe the surface of Fe-protected Al foils. The samples were transferred in air. In the case of electrochemically tested samples, care was taken to reduce the transfer time to under 30 s.

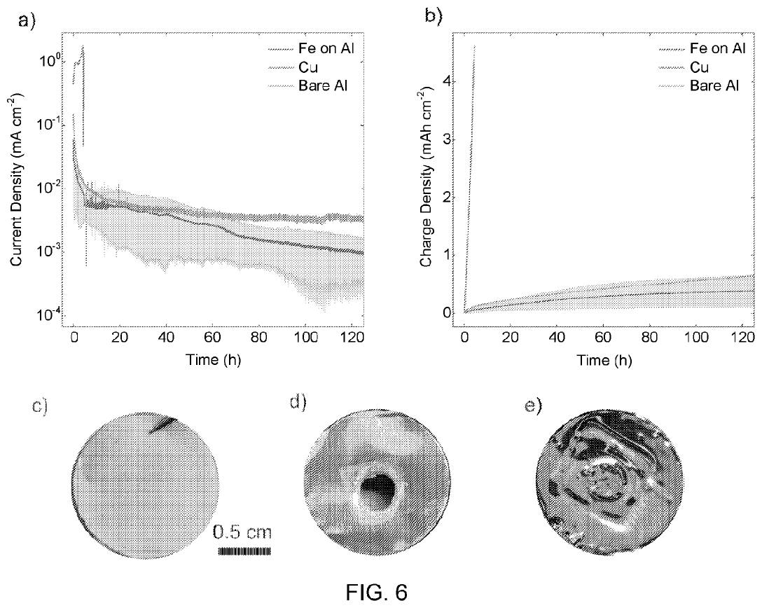

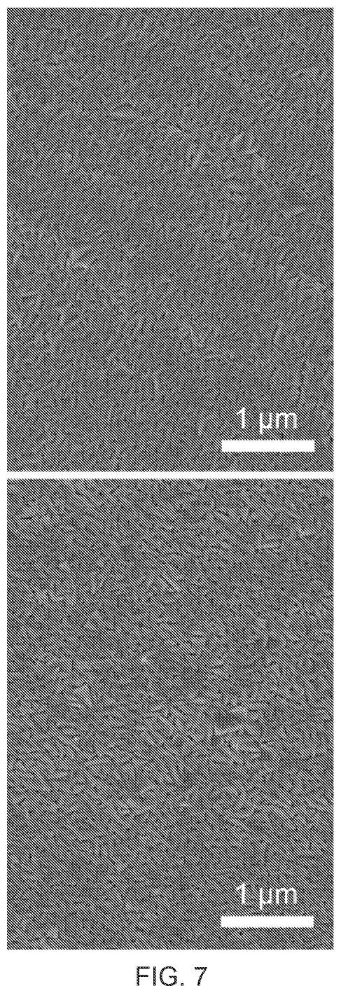

Results and Discussion. FIG. 6 shows the stability of Fe-protected Al foils in comparison to bare Al and Cu current collectors. In this test, 800 nm of Fe was sputtered on commercial Al foils. The foils were used as the working electrode in a coin cell with metallic lithium as the counter electrode. Prior to the potentiostatic hold at 10 mV vs Li/Li⁺ shown in FIG. 6, the cell was brought from open circuit potential (around 3 V) through a linear voltage sweep at a rate of 0.1 mV/s. This protocol resembles battery charge and then simulates the electrochemical environment of the current collector when the anode is fully lithiated for extended periods of time. The comparison in FIG. 6 Panel a shows that the evolution of current in the Fe-protected aluminum current collectors is essentially identical to the case of standard copper current collectors. In comparison, bare aluminum evolves current densities two orders of magnitude higher than what is observed for copper current collectors. This larger current density in bare aluminum is related to large morphological changes in the foil as shown in FIG. 6 Panel d. In this case, the bare Al foil was completely pulverized during reaction with lithium, leaving a hole in the reacted area directly underneath the Li electrode.

In contrast, the lower current densities are correlated with no visible changes in the morphology or mechanical integrity of the foils, as shown in FIG. 6 Panels c and e. In the case of the Fe-protected Al foil, no pulverization occurred. Although the foil does not appear flat as compared to the Cu foil, this is not due to decomposition of the Al foil. Instead, it is due the fact that the Al foil was supported on carbon tape on a stainless steel spacer prior to sputtering. During the fabrication of the coin cell, the separator and Li electrode are pressed against the foil, deforming the underlying carbon tape. In the case of Cu or bare Al foil, no carbon tape was used, which is why those foils appear flat after the electrochemical testing procedure.

The observed current can come from various sources. In the case of bare Al, most of the current comes from the reaction with Li, while in the case of bare Cu the current likely comes from electrolyte decomposition. FIG. 6 Panel b shows the cumulative charge density transferred corresponding to the current density plots in FIG. 6 Panel a. Assuming Al reacts with Li to form LiAl with a theoretical capacity of 993 mAh cm⁻³, the areal charge density transferred during lithiation of a 15-μm foil should be ˜4 mAh cm⁻². It can be seen that the bare Al foil reaches that charge density within less than 5 hours, suggesting rapid lithiation of Al. This lithiation causes a volume change of 90% and is known to induce pulverization in Al anodes, which is consistent with the foil destruction observed in FIG. 6 Panel d.

The current evolution in Cu current collectors has a different origin. As shown in FIG. 6 Panels a and b, the current density and cumulative charge density of Cu is significantly lower than that of Al, but it is non-zero. This appears to arise from Cu continuously reacting with the electrolyte at the Cu surface and not from lithiation of the Al foil.

The mechanical stability of the Fe films was further confirmed through electron microscopy. The upper image in FIG. 7 shows the morphology of a pristine Fe film on an Al foil (top view). A cross section of the film shows the polycrystalline structure of the film and the abundance of grain boundaries perpendicular to the Al substrate. The lower image in FIG. 7 shows a top view of the film after 120 h of potentiostatic hold at 10 mV, obtained after rinsing the sample with water and acetone to remove any SEI, showing a very similar structure as the pristine Fe film. No evidence of damage in the Fe film (such as cracks or flakes) was found when compared to the pristine samples.

The electrochemical tests on flooded cells provide evidence that extended stability of Al current collectors is possible. The longest time before failure demonstrated in this cell configuration was over 1000 h, more than three orders of magnitude longer than without the protection. This experimental evidence indicates that Fe may indeed be preventing the lithiation of Al.

FIG. 8 Panels a and b show the current transients of flooded cells over extended periods of time. Low current densities were observed for hundreds of hours, with a dramatic increase towards the end. This increase in current density above 0.1 mA cm⁻² is indicative of failure. FIG. 8 Panel e shows the backside of a flooded cell after failure. The dotted circle shows an obvious change in the mechanical integrity of the foil. This suggests that rather than being a gradual process, once Li reaches Al through a defect, the reaction cascades rapidly. This may occur because of the volume expansion of Al upon lithiation. This volume expansion would act to break the protective film and induce more defects, exposing more Al to the liquid electrolyte and the Li reservoir.

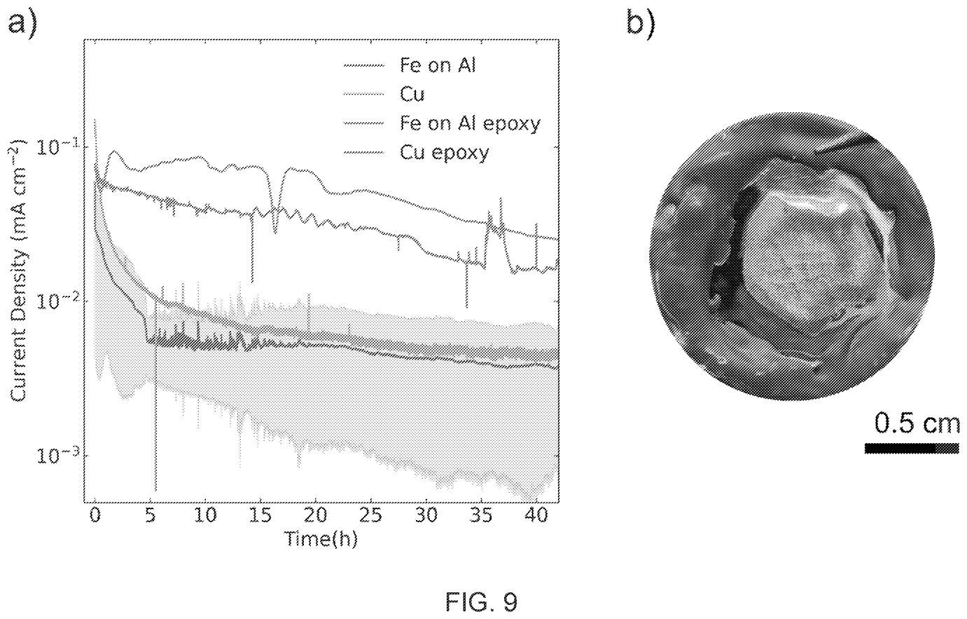

An important consideration in the analysis of flooded cells is the role of the epoxy used to seal them. The epoxy was in direct contact with the Fe protective layer and the liquid electrolyte, which means that it was subjected to the same electrochemical environment and prone to decomposition. To explore this possibility, coin cells with and without epoxy were constructed and compared, with results shown in FIG. 9. It is clear from FIG. 9 Panel a that Cu cells with epoxy evolve current densities about an order of magnitude higher than those without epoxy. This result translates to Fe-protected Al. Additionally, the Fe-protected Al cells with epoxy develop an SEI layer that is several microns in thickness. Such thick SEI is not visible in cells without epoxy, which suggests that the epoxy molecules are being reduced to form SEI. This observation indicates that the current density values obtained in flooded cells may be inflated. Additionally, the fact that failure was observed in the flooded cells suggests that the decomposition of the epoxy is not playing a role in extending the stability of those cells. These experiments highlight the importance of careful selection of materials and strategies to protect the edges and back of the Fe-protected Al current collectors in future applications.

Conclusions. This Example demonstrates that Fe is a suitable material to prevent lithiation of Al foils at low potentials. Potentiostatic holds at 10 mV vs Li/Li⁺ show that Fe-protected Al foils produce current densities comparable to Cu current collectors and can remain stable for more than 1000 h. No obvious morphological changes were observed after more than 100 h of potentiostatic holds. When failure occurs, the current density increases suddenly, suggesting that the failure process cascades rapidly. This failure may be due to the presence of defects in the Fe film. The results presented here support the use of Al anode current collectors as a replacement of Cu in Li-ion batteries.

Figure Captions. FIG. 6. Performance of Fe protection layer on Al compared to Cu and bare Al. Panel a: Evolution of current density over 120 h of a potentiostatic hold at 10 mV for Cu, bare, and Fe-protected Al. The darker blue line represents the average of 3 replicates of the same experimental condition, and the light blue area shows the standard deviation. Panel b: Evolution of transferred charge density corresponding to the experiments in Panel a. Photographs of Cu (Panel c), bare Al (Panel d), Fe-Protected Al (Panel e) after potentiostatic hold at 10 mV. Notice the hole in Panel d matching the shape and location of the Li electrode. The imprint of the separator and Li electrode are only visible in Panel e because the foil was fixed with carbon tape on a steel current collector while the other samples had no carbon tape.

FIG. 7. Scanning electron microscopy images of the sputtered Fe film. Upper image: Top view of a pristine Fe film sample. Lower image: Top view of a Fe-protected film after 120 h of potentiostatic hold at 10 mV rinsed with water and acetone. The lower images was taken from the region that sat directly below the Li electrode.

FIG. 8. Flooded cell configuration and demonstration of long stability. Panel a: Current density evolution of various foils in flooded cells during potentiostatic hold at 10 mV. Panel b: Charge density evolution corresponding to the experiments in Panel a. Panel c: Schematic of the flooded cell configuration. Panel d: Photograph of a flooded cell. Panel e: Back-side of a Fe-protected Al foil during failure. The dotted circle marks the location of the active components of the flooded cell.

FIG. 9. Effects of epoxy on current density evolution. Panel a: Current density evolution of various coin cells with and without epoxy. Panel b: Photograph of a Fe-protected foil sealed with epoxy after 120 h of potentiostatic hold at 10 mV showing a thick, grey SEI in the central area of the foil.

### ILLUSTRATIVE ASPECTS

As used below, any reference to a series of aspects (e.g., “Aspects 1-4”) or non-enumerated group of aspects (e.g., “any previous or subsequent aspect”) is to be understood as a reference to each of those aspects disjunctively (e.g., “Aspects 1-4” is to be understood as “Aspects 1, 2, 3, or 4”).

Aspect 1 is a substrate comprising: an aluminum alloy layer; and a conductive protection layer in contact with the aluminum alloy layer.

Aspect 2 is the substrate of any previous or subsequent aspect, wherein the conductive protection layer prevents transmission of lithium atoms or lithium ions to the aluminum alloy layer.

Aspect 3 is the substrate of any previous or subsequent aspect, wherein the conductive protection layer is free or substantially free of imperfections allowing transmission of lithium atoms or lithium ions to the aluminum alloy layer.

Aspect 4 is the substrate of any previous or subsequent aspect, wherein the conductive protection layer is free or substantially free of imperfections extending between a surface of the conductive protection layer facing the aluminum alloy layer and an opposite surface of the conductive protection layer.

Aspect 5 is the substrate of any previous or subsequent aspect, wherein the conductive protection layer comprises a coating on the aluminum alloy layer.

Aspect 6 is the substrate of any previous or subsequent aspect, wherein the conductive protection layer coats all or a portion of the aluminum alloy layer.

Aspect 7 is the substrate of any previous or subsequent aspect, wherein the aluminum alloy layer comprises a coating on the conductive protection layer.

Aspect 8 is the substrate of any previous or subsequent aspect, wherein the conductive protection layer comprises a complete encapsulation layer over all or the portion of the aluminum alloy layer.

Aspect 9 is the substrate of any previous or subsequent aspect, wherein the conductive protection layer comprises a material that does not alloy with lithium.

Aspect 10 is the substrate of any previous or subsequent aspect, wherein the conductive protection layer does not include materials that alloy with lithium.

Aspect 11 is the substrate of any previous or subsequent aspect, wherein the conductive protection layer does not include aluminum, zinc, magnesium, silicon, germanium, tin, indium, antimony, or carbon.

Aspect 12 is the substrate of any previous or subsequent aspect, wherein the conductive protection layer has a purity of 70 wt. % or more.

Aspect 13 is the substrate of any previous or subsequent aspect, wherein the conductive protection layer comprises a material that does not react with lithium at a potential of from 0 V to 5 V vs. Li/Li+.

Aspect 14 is the substrate of any previous or subsequent aspect, wherein the conductive protection layer comprises one or more of titanium, chromium, iron, nickel, molybdenum, tungsten, copper, or titanium nitride.

Aspect 15 is the substrate of any previous or subsequent aspect, wherein the conductive protection layer comprises a composite structure.

Aspect 16 is the substrate of any previous or subsequent aspect, wherein the composite structure comprises at least a first sub-layer and a second sub-layer, and wherein the first sub-layer and the second sub-layer comprise the same material or different materials.

Aspect 17 is the substrate of any previous or subsequent aspect, wherein one or more sub-layers of the composite each independently have a purity of 70 wt. % or more.

Aspect 18 is the substrate of any previous or subsequent aspect, wherein the conductive protection layer comprises a physically deposited layer, a sputter deposited layer, an evaporation deposition deposited layer, a chemically deposited layer, an electrodeposition deposited layer, an electroplating layer, a chemical vapor deposition deposited layer, or an atomic layer deposition deposited layer.

Aspect 19 is the substrate of any previous or subsequent aspect, wherein the conductive protection layer comprises a crystalline structure or a polycrystalline structure.

Aspect 20 is the substrate of any previous or subsequent aspect, wherein the conductive protection layer has an oxygen content of 30 wt. % or less.

Aspect 21 is the substrate of any previous or subsequent aspect, wherein the conductive protection layer comprises a metal layer having an impurity content of 1 wt. % or less.

Aspect 22 is the substrate of any previous or subsequent aspect, wherein the conductive protection layer has an electrical conductivity of from 105 S/m to 108 S/m or an electrical resistivity of from 10⁻⁸ Ω·m to 10⁻⁶ Ω·m.

Aspect 23 is the substrate of any previous or subsequent aspect, wherein the conductive protection layer has a thickness of from 10 nm to 100 μm or from 1 μm to 500 μm.

Aspect 24 is the substrate of any previous or subsequent aspect, wherein the conductive protection layer a metal or metal alloy sheet or metal or metal alloy foil.

Aspect 25 is the substrate of any previous or subsequent aspect, wherein the conductive protection layer comprises a first foil, wherein the aluminum alloy layer comprises a second foil, and wherein the first foil and the second foil are bonded to one another.

Aspect 26 is the substrate of any previous or subsequent aspect, wherein the aluminum alloy layer comprises an aluminum alloy sheet or an aluminum alloy foil.

Aspect 27 is the substrate of any previous or subsequent aspect, wherein the aluminum alloy layer has a thickness of from 10 nm to 100 μm or from 1 μm to 500 μm.

Aspect 28 is the substrate of any previous or subsequent aspect, comprising or corresponding to an electronic substrate.

Aspect 29 is the substrate of any previous or subsequent aspect, comprising or corresponding to a current collector.

Aspect 30 is the substrate of any previous or subsequent aspect, comprising or corresponding to a current collector for an electrochemical cell, a capacitor, or a supercapacitor.

Aspect 31 is the substrate of any previous or subsequent aspect, comprising or corresponding to a current collector for a lithium ion electrochemical cell.

Aspect 32 is the substrate of any previous or subsequent aspect, comprising or corresponding to an anode current collector or a cathode current collector.

Aspect 33 is a device comprising: an aluminum alloy layer, wherein the aluminum alloy layer corresponds to a current collector for an electrode; a conductive protection layer in contact with the aluminum alloy layer; and an electrode active material in contact with the conductive protection layer.

Aspect 34 is the device of any previous or subsequent aspect, comprising or corresponding to an electrochemical cell electrode.

Aspect 35 is the device of any previous or subsequent aspect, wherein the electrode active material comprises a lithium ion cathode active material or a lithium ion anode active material.

Aspect 36 is the device of any previous or subsequent aspect, comprising or corresponding to an electrochemical cell or a battery.

Aspect 37 is the device of any previous or subsequent aspect, wherein the aluminum alloy layer, the conductive protection layer, and the electrode active material comprise or correspond to a first electrochemical cell electrode, and wherein the device further comprises: a second electrochemical cell electrode; and an electrolyte positioned between the first electrochemical cell electrode and the second electrochemical cell electrode.

Aspect 38 is the device of any previous or subsequent aspect, further comprising: electronic device circuitry in direct or indirect electrical communication with and drawing or receiving current from the first electrochemical cell electrode or the second electrochemical cell electrode.

Aspect 39 is the device of any previous or subsequent aspect, comprising or corresponding to a portable electronic device.

Aspect 40 is the device of any previous or subsequent aspect, wherein the aluminum alloy layer and the conductive protection layer comprise or correspond to the substrate of any previous or subsequent aspect.

Aspect 41 is a method of making a substrate, the method comprising: providing an aluminum alloy layer; and contacting the aluminum alloy layer with a conductive protection layer.

Aspect 42 is the method of any previous or subsequent aspect, wherein the contacting comprises depositing the conductive protection layer as a coating on the aluminum alloy layer using one or more of a physical deposition process, a sputter deposition process, an evaporation deposition process, a chemical deposition process, an electrodeposition process, an electroplating process, a chemical vapor deposition process, or an atomic layer deposition process.

Aspect 43 is the method of any previous or subsequent aspect, wherein the contacting comprises depositing the conductive protection layer as multiple separate coating processes.

Aspect 44 is the method of any previous or subsequent aspect, wherein the conductive protection layer comprises a composite structure, and wherein the contacting comprises: depositing a first sub-layer on the aluminum alloy layer; and depositing a second sub-layer on the first sub-layer.

Aspect 45 is the method of any previous or subsequent aspect, wherein the contacting comprises depositing the aluminum alloy layer as a coating on the conductive protection layer using one or more of a physical deposition process, a sputter deposition process, an evaporation deposition process, a chemical deposition process, an electrodeposition process, an electroplating process, a chemical vapor deposition process, or an atomic layer deposition process.

Aspect 46 is the method of any previous or subsequent aspect, wherein the aluminum alloy layer comprises an aluminum alloy foil and wherein the conductive protection layer comprises a coating on the aluminum alloy foil.

Aspect 47 is the method of any previous or subsequent aspect, wherein the conductive protection layer comprises a metal or metal alloy foil and wherein the aluminum alloy layer comprises a coating on the metal or metal alloy foil.

Aspect 48 is the method of any previous or subsequent aspect, wherein the aluminum alloy layer comprises an a first foil, wherein the conductive protection layer comprises a second foil, and wherein the contacting comprises bonding the first foil and the second foil.

Aspect 49 is the method of any previous aspect, wherein the substrate comprises the substrate of any previous aspect.

All patents and publications cited herein are incorporated by reference in their entirety. The foregoing description of the embodiments, including illustrated embodiments, has been presented only for the purpose of illustration and description and is not intended to be exhaustive or limiting to the precise forms disclosed. Numerous modifications, adaptations, and uses thereof will be apparent to those skilled in the art.

1. A substrate comprising:
an aluminum alloy layer; and
a conductive protection layer in contact with the aluminum alloy layer.

2. The substrate of claim 1, wherein the conductive protection layer prevents transmission of lithium atoms or lithium ions to the aluminum alloy layer.

3. The substrate of claim 1, wherein the conductive protection layer is free or substantially free of imperfections allowing transmission of lithium atoms or lithium ions to the aluminum alloy layer, or wherein the conductive protection layer is free or substantially free of imperfections extending between a surface of the conductive protection layer facing the aluminum alloy layer and an opposite surface of the conductive protection layer.

4. (canceled)

5. The substrate of claim 1, wherein the conductive protection layer comprises a coating on the aluminum alloy layer.

6. The substrate of claim 1, wherein the conductive protection layer coats all or a portion of the aluminum alloy layer or wherein the aluminum alloy layer comprises a coating on the conductive protection layer.

7. (canceled)

8. The substrate of claim 5, wherein the conductive protection layer comprises a complete encapsulation layer over all or a portion of the aluminum alloy layer.

9. The substrate of claim 1, wherein the conductive protection layer comprises a material that does not alloy with lithium or wherein the conductive protection layer does not include materials that alloy with lithium.

10. (canceled)

11. The substrate of claim 1, wherein the conductive protection layer does not include aluminum, zinc, magnesium, silicon, germanium, tin, indium, antimony, or carbon or wherein the conductive protection layer comprises one or more of titanium, chromium, iron, nickel, molybdenum, tungsten, copper, or titanium nitride.

12. The substrate of claim 1, wherein the conductive protection layer has a purity of 70 wt. % or more, wherein the conductive protection layer comprises a metal layer having an impurity content of 1 wt. % or less, or wherein the conductive protection layer has an oxygen content of 30 wt. % or less.

13. The substrate of claim 1, wherein the conductive protection layer comprises a material that does not react with lithium at a potential of from 0 V to 5 V vs. Li/Li⁺.

14. (canceled)

15. The substrate of claim 1, wherein the conductive protection layer comprises a composite structure.

16. The substrate of claim 15, wherein the composite structure comprises at least a first sub-layer and a second sub-layer, and wherein the first sub-layer and the second sub-layer comprise the same material or different materials, or wherein one or more sub-layers of the composite each independently have a purity of 70 wt. % or more.

17.-18. (canceled)

19. The substrate of claim 1, wherein the conductive protection layer comprises a crystalline structure or a polycrystalline structure.

20.-21. (canceled)

22. The substrate of claim 1, wherein the conductive protection layer has an electrical conductivity of from 10⁵ S/m to 10⁸ S/m or an electrical resistivity of from 10⁻⁸ Ω·m to 10⁻⁶ Ω·m.

23. The substrate of claim 1, wherein the conductive protection layer has a thickness of from 10 nm to 100 μm or from 1 μm to 500 μm or wherein the aluminum alloy layer has a thickness of from 10 nm to 100 μm or from 1 μm to 500 μm.

24. The substrate of claim 1, wherein the conductive protection layer is a metal or metal alloy sheet or metal or metal alloy foil or wherein the aluminum alloy layer comprises an aluminum alloy sheet or an aluminum alloy foil.

25. The substrate of claim 1, wherein the conductive protection layer comprises a first foil, wherein the aluminum alloy layer comprises a second foil, and wherein the first foil and the second foil are bonded to one another.

26.-27. (canceled)

28. The substrate of claim 1, comprising or corresponding to an electronic substrate or a current collector.

29.-32. (canceled)

33. A device comprising:
an aluminum alloy layer, wherein the aluminum alloy layer corresponds to a current collector for an electrode;
a conductive protection layer in contact with the aluminum alloy layer; and
an electrode active material in contact with the conductive protection layer.

34. The device of claim 33, comprising or corresponding to an electrochemical cell electrode, an electrochemical cell, or a battery.

35. The device of claim 33, wherein the electrode active material comprises a lithium ion cathode active material or a lithium ion anode active material.

36. (canceled)

37. The device of claim 33, wherein the aluminum alloy layer, the conductive protection layer, and the electrode active material comprise or correspond to a first electrochemical cell electrode, and wherein the device further comprises:
a second electrochemical cell electrode; and
an electrolyte positioned between the first electrochemical cell electrode and the second electrochemical cell electrode.

38.-40. (canceled)

41. A method of making a substrate, the method comprising:
providing an aluminum alloy layer; and
contacting the aluminum alloy layer with a conductive protection layer.

42. The method of claim 41, wherein the contacting comprises depositing the conductive protection layer as a coating on the aluminum alloy layer using one or more of a physical deposition process, a sputter deposition process, an evaporation deposition process, a chemical deposition process, an electrodeposition process, an electroplating process, a chemical vapor deposition process, or an atomic layer deposition process.

43.-49. (canceled)
